(19) United States
(12) Patent Application Publication
(10) Pub. No.: US 2022/0327609 A1
(43) Pub. Date: Oct. 13, 2022

(54) HEATED SKI BOOT HARDWARE AS A SERVICE

(71) Applicant: ROSSLAND BINDING COMPANY, Red Deer (CA)

(72) Inventors: Rob C. Barden, Red Deer (CA); Blair L. Fredericks, Penticton (CA)

(21) Appl. No.: 17/697,458

(22) Filed: Mar. 17, 2022

Related U.S. Application Data
(60) Provisional application No. 63/172,308, filed on Apr. 8, 2021.

(51) Int. Cl. G06Q 30/06; A43B 3/35; A43B 5/04; H04W 4/30

(52) U.S. Cl. CPC G06Q 30/0645; A43B 3/35; A43B 5/04; H04W 4/30

(57) ABSTRACT

An example ski boot includes a shell, a liner, and a heating system. The heating system includes a heating element disposed inside the shell, such as in the liner, and heating element circuitry connected to the heating element, and the heating element circuitry includes a charging port, a rechargeable power source connected to the charging port and to the heating element, and a charge counter circuit connected to the charging port and to the rechargeable power source, wherein the charge counter circuit is operable to count a number of times that the rechargeable power source has received power by way of the charging port.

### FIELD OF THE INVENTION

At least some example embodiments of the present disclosure are generally concerned with sporting equipment and, in particular, with a cold weather boot, such as a ski boot or snowboard boot, that includes a heater which, upon payment of a fee and/or satisfaction of other criteria, may be selectively activated ‘n’ times by a user.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture.

FIG. 2 is a flow diagram disclosing an example method for registering a pair of ski boots and updating a charge count of the ski boots.

FIG. 3 is a flow diagram disclosing an example method for operation of a heating system that includes a charge count circuit.

FIG. 4 is a block wiring diagram of an example heating system.

FIG. 5 is a computing entity operable to carry out any of the disclosed methods and processes.

### DETAILED DESCRIPTION

The present disclosure is generally concerned with footwear, such as boots for example, that may be used in cold weather and/or in other conditions where the wearer could be exposed to low temperatures. Note that while the disclosure herein, including the following example, may refer at times to a single boot, it is contemplated that all of the presently disclosed concepts may be equally applied to each boot of a pair of boots, and/or may be applied to the boots as a pair. As well, the disclosed concepts may be applied to multiple pairs of boots, such as in a case where a group of people, such as a family for example, needs multiple pairs of boots.

More particularly, some embodiments of the invention embrace a cold weather boot that includes a heater which may be selectively activated ‘n’ number of times, and/or for a set amount of time or specified time period, such as by a user, upon payment and/or satisfaction of other criteria. For example, the user of the boot may use a mobile phone or other device to access an app or website to provide a credit card number and, upon successful processing of the credit card, the user may receive an unlock code by way of the app or website, such as on a mobile phone for example, which may enable the user to activate the heater a certain number of times, and/or during a specified time period, based upon the amount of the fee that was paid. Activation of the heater may be implemented using Bluetooth or other communication protocol. In some cases, the boot circuitry may be configured to collect, store, and transmit various data such as, for example, the number of times the heater was activated, when the heater was activated/deactivated, how long the heater was active, and the temperature setting of the heater such as low, medium, or high, for example. Upon user consent, the boot circuitry and/or the app may collect data such as a user email address and phone number for example, as well as GPS (global positioning system) coordinates that may be collected while the heater is operating.

While not required, it is noted that embodiments of the invention may be particularly well suited for use in rental markets where one or more pairs of heated boots are provided by an enterprise, such as a ski resort or ski shop for example, for rental by a customer. The rental may be for any time period, such as a day or half day for example, but may be shorter than a half day, or longer than a day, such as about a week, for example.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed cc embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

An embodiment of the invention may enable a user to try a heated boot at low, or no, initial cost. An embodiment of the invention may enable a user or other party to track usage of a heater of a heated boot. An embodiment of the invention may enable a user to activate a heater of a boot a specified number of times, for a set amount of time, or for a specified time period. An embodiment of the invention may enable a user to purchase, or rent, a boot that includes a heater which the user may activate only on an as-needed basis. This configuration may enable the boot to be sold at a lower initial cost than if the user were to purchase a boot with a heater configured for unrestricted use. An embodiment of the invention may enable a heater circuit to count recharge cycles for a power source used by a heating element controlled by the heater circuit. Finally, an embodiment of the invention may enable a user to obtain selective use of a boot heater on a subscription basis, where the subscription may be a paid subscription, or free subscription for a limited time. The subscription may be for a set amount of time, or may cover a specified time period.

### A. General Aspects of Some Example Embodiments

In general, the cold weather boots, examples of which include, but are not limited to, ski boots and snowboard boots, and heaters disclosed herein may be constructed with a variety of components and materials including, but not limited to, adhesives, plastic, rubber, metal, fiberglass, composites, polytetrafluouroethylene (PTFE), carbon fiber, and any combination of these. Suitable metals may include brass, steel. titanium, aluminum, and aluminum alloys, although the skilled person will understand that a variety of other metals may be employed as well and the scope of the invention is not limited to the foregoing examples. These construction materials may be employed in connection with a variety of processes including, but not limited to, machining, injection molding, and die casting.

Depending upon the material(s) employed in the construction of the boots and associated circuitry and other components, a variety of methods and components may be used to connect, releasably or permanently, various elements of the aforementioned devices. For example, the various elements of embodiments within the scope of this disclosure may be attached to each other by any one or more of processes such as molding, welding, brazing, and/or mechanically by way of fasteners such as bolts, screws, pins, studs, and rivets, for example.

The circuitry that may be employed in various embodiments may comprise any circuitry configured, or configurable, to perform any one or more of the disclosed functions. Thus, the scope of the invention is not limited to the example components and circuits disclosed herein. Example circuits, components, and functionality, include, but are not cc limited to, power, control, wireless communication, Bluetooth, wireless transmission and reception, cache memory, data storage, charge cycle counters, clocks, FPGAs (Field Programmable Gate Array), ASICs (Application-Specific Integrated Circuits), timers, radio frequency (RF), power source charging, battery chargers, wireless receivers, wireless transmitters, and antennas, for example. Note that Bluetooth® refers to a short-range wireless technology standard that is used for exchanging data between fixed and mobile devices over short distances using UHF radio waves in the ISM bands, from 2.402 GHz to 2.48 GHz. See https://www.bluetooth.com/.

Finally, a heating element, or heating elements, as disclosed herein may be may positioned in various locations and components of a boot, such as a ski boot. For example, a heating element may be partly, or completely, embedded in a liner of a boot, such as a ski boot. In other embodiments, a heating element may be partly, or completely, embedded in a shell of a boot. More generally, a heating element may be located anywhere in, and in any component of, a boot such that, when activated, the heating element operates to transmit heat to an interior portion of the boot.

### B. Overview

Winter snow sports, such as skiing and snowboarding for example, only happen if there is cold weather, and snow to ski or ride on. A key consideration in enjoyment of winter sports is the ability to stay warm. Heated equipment, including cold weather boots such as ski boots and snowboard boots, can help enhance enjoyment of the outdoors. A number of manufacturers offer cold weather boots that include integrated heaters installed at the time the boot is manufactured, and heaters may also be installed after-the-cc fact in cold weather boots as an after-market item. At the present time, ski boots sold with integrated heaters typically cost approximately $100 to $200 more than ski boots without heaters.

The typical consumer, while likely to appreciate the comfort offered by heated boots, may have a difficult time justifying the extra expense for a pair of heated ski boots. Price is often an important metric for the buyer, particularly so with the already high, and ever-increasing, cost of resort snowboarding and skiing lift tickets, and the additional expense imposed by heated boots may be a contributor to the relatively low sales to date for this category of ski boots. However, if a user had an opportunity to try a heated boot, the user may be persuaded that the additional cost is justified. Thus, an opportunity may exist to enable a user to use a heated boot, while also enabling the user to avoid the relatively high initial cost for the purchase of a heated boot.

The following example is illustrative of one approach that may be taken by an embodiment of the invention to address circumstances such as those just noted. This example is for the purposes of illustration, and is not intended to limit the scope of the invention in any way.

Initially, a user may purchase a pair of ski boots, where each ski boot includes a respective heater. The ski boots may, initially after purchase, deliver a set number of power source charging cycles, such as 3 for example, at no cost to the user, and without requiring any action on the part of the user other than to activate the heaters when needed. One or more of the charging cycles may last for a set period of time, depending upon available battery power, such as about 6 hours for example.

Each time the heaters are activated, the number of remaining available cycles, which may be kept track of by a counter, may be reduced by 1. As an alternative to the use of charging cycles, the user may be permitted unlimited use of the heaters during a specified clock or calendar period of time, such as Monday through Wednesday (72 hours), for example. In still another alternative approach, the user may be permitted a set total amount of time to use the heaters, such as 18 hours for example, at no charge. In this alternative approach, the user may activate and deactivate the heaters as needed and the heaters can be active for the total specified amount of time. The 18 hours of use could be consumed over time periods of various length, such as 3 days (6 hours of use per day), or 9 days (2 hours of use per day), for example. The former example may apply to a resort skier who spends more time sitting on the chairlift than skiing and, as a result, is not exerting himself for much of the time. The latter example may apply to a backcountry skier or split-boarder who, because she is spending significant effort skinning uphill, may find it easier to stay warm than the resort skier and, as such, may only need the boot heaters activated for a short period of time.

A clock circuit associated operably connected with the heaters may track the total amount of time that the heaters are activated. A single clock circuit may connect, wirelessly for example, to both boot heaters, or, a respective clock circuit may be provided for each boot heater. In the latter case, the clock circuits may be hardwired to their respective boot heaters. In still other embodiments, the heaters may be activated, or activatable, for a specified calendar time period, such as March 1-6 for example. The heaters may be independently configured to provide different amounts of heat, depending cc on user preference, such as “LOW,” “MEDIUM,” and “HIGH” for example. After the post-purchase initial trial period is over, that is, the user has used the allotted cycles, or allotted time, the heaters can no longer be activated by the user and the user must purchase additional cycles or time. Such prevention of unauthorized use of the heaters may be achieved in various ways. For example, charging of the power source to the heaters may be prevented by disablement or disconnection of the charging circuit. As another example, the power source may be chargeable, but the supply of power from the power source to the heaters may be prevented, such as by disconnection of the power source.

The purchase of additional charging cycles, or allotted time, may be effected, for example, by a user accessing a vendor website through an app on a device such as a mobile phone. In addition to being prompted by the website for a credit card number, the user may be prompted by the website and/or app to provide other user-specific information such as email address, and phone number, for example.

In one embodiment, successful processing of a user credit card, Venmo® transfer, or PayPal® transfer, such as by way of the app for example, may result in an authorization code being generated and sent from the vendor to the user. Again, the authorization code may be received by the user from the vendor by way of the app, text (SMS), email, vendor website, and/or any other suitable medium.

The authorization code, which may be a single-use code, may be specific to the boots, such as ski boots, of the user and may not be able to be used to activate heaters in any other boots. For example, the authorization code may be specific, and transmitted, to cc a ski boot MAC (Media Access Control) address, or IP (Internet Protocol) address, that is unique to the ski boots of the user. As such, the ski boots are considered, in some embodiments at least, to constitute and implement an IoT (Internet of Things) physical device that is able to communicate wirelessly, and/or by way of a wired connection, with one or more other network connected/connectible devices. In some instances, each boot of a pair may have a unique MAC, or other, address, and the MAC, or other, addresses may be associated to each other so that the boots are authorized as a pair, although the boots may be authorized individually, that is, independent of each other, in some embodiments. After the user enters the authorization code, such as by way of the app for example, the app or other system/device may communicate wirelessly to the ski boots to authorize the additional charging cycles, or allotted time, purchased by the user. The user can then use the additional charging cycles or allotted time.

In some instances, various information concerning usage of the heaters may be collected, stored, and transmitted by the heaters and/or by the app. Such information may include, but is not limited to, the date and time of each heater activation, the duration of each activation, the number of days the heaters were used, and whether one or more of the heaters exhibit signs of problems or malfunctions, such as, but not limited to, overheating, underheating, failure to heat, failure to charge, or current drain.

### C. Example Architecture and Operating Environment

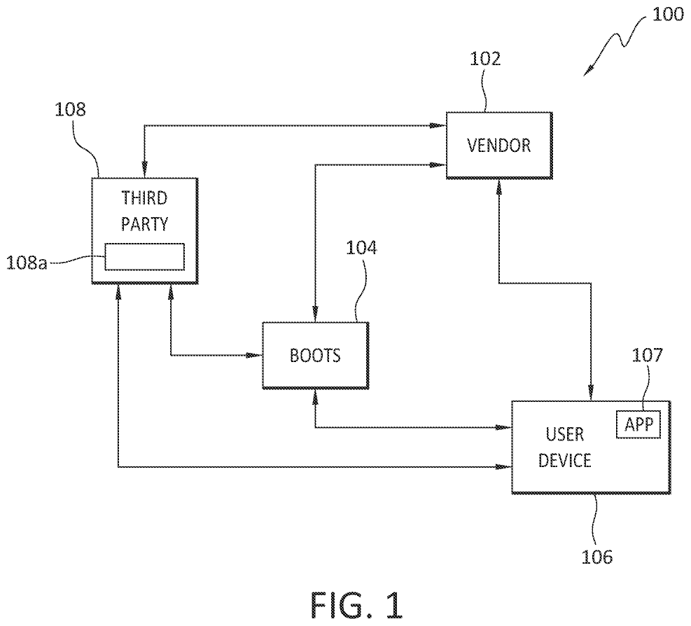

With attention now to FIG. 1, details are provided concerning an example architecture and operating environment 100, which may be referred to herein simply as an ‘architecture.’ As indicated, the example architecture 100 may comprise a vendor site 102, cc one or more pairs of ski boots 104, one or more user devices 106 that may include an app and one or more third party sites 108 such as a ski resort or rental store for example. Any of the entities of the architecture 100 may communicate with any of the other entities of the architecture 100, such as by wireless and/or hardwire connections, and such communication between entities may take place directly and/or by way of a network. No particular mode of communication, or communication medium, between entities is necessarily required by any embodiment. Any function attributed herein to a user may be effected, in whole or in part, by way of the app 107, although that is not necessarily required. For example, in some embodiments, a user may access a vendor 102 website by way of a browser on a user mobile phone, or other computing device.

In some embodiments, an authorization/charging kiosk 108a may be provided, such as at the third party site 108 for example. Where such an authorization/charging kiosk 108a is provided, the user may be able to obtain authorization, and charge her boot heater power sources, at a single location, and in a single operation. For example, if the boot heater power sources are not already charged, the user may connect her boots 104 to a charging connection and power source of the authorization/charging kiosk 108a, and the authorization/charging kiosk 108a may, upon successful completion of a credit card, or other, transaction, automatically begin charging the boot heater power sources. The user may be notified, such as by way of the app 107 for example, when charging has completed. The authorization/charging kiosk 108a may include a credit card slot or other credit card reader operable to process credit card charges and/or may be configured to communicate wirelessly with user equipment, such as a mobile phone, to effect a transaction.

### D. Example Methods

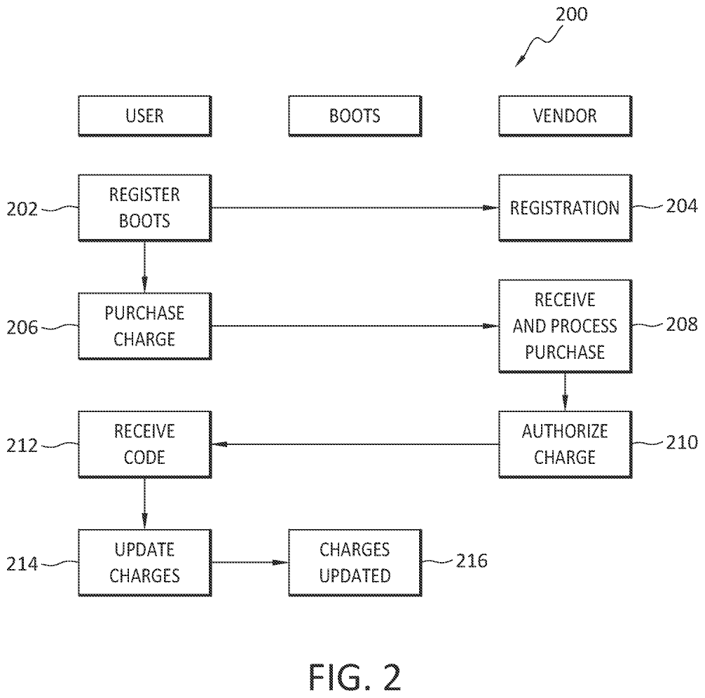

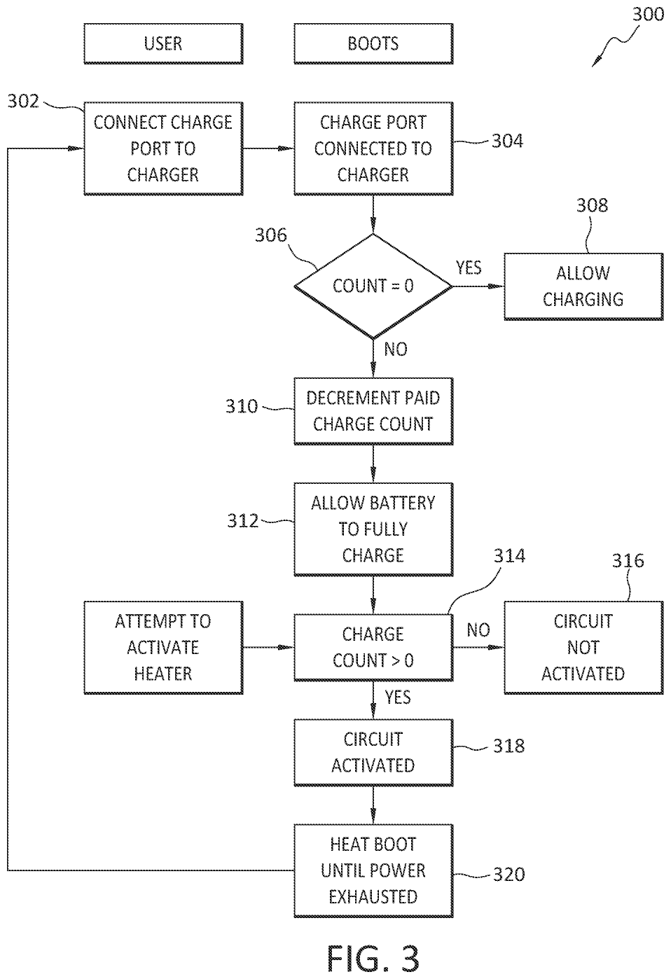

It is noted with respect to the example methods of FIGS. 2 and 3 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

With the example architecture 100 in view, attention is directed now to FIG. 2, which discloses an example method 200 according to some embodiments of the invention. In general, the example method 200 is directed to the authorization of charges, or allotted time, for a pair of cold weather boots, such as ski boots or snowboard boots for example, that each include a heater for use in warming the foot of a user. A further method for operation of the boots is disclosed in FIG. 3, discussed below.

Initially, the method 200 may begin when a user initiates registration 202 of a pair of boots. Registration may be accomplished, for example, by submitting the boot MAC addresses, and/or other identifying information, to a vendor site, where the boots are then registered 204. The MAC addresses and/or other information may be submitted by the user by way of a vendor website, a vendor app on a user computing device, or other mechanism. The MAC addresses may each be associated with respective Bluetooth connections, such as BLE (Bluetooth Low Energy), of the boots. It is noted that Bluetooth technology and cc specifications are not required for any embodiment, and other forms of wireless near field communications (NFC) may be used, as well as radio frequency (RF) communication, and communications conforming to the IEEE 802.11X protocols. While not specifically indicated in FIG. 2, the vendor website or other vendor site may notify the user, such as by way of an app or email for example, when the boots have been successfully registered. Similarly, the user may be notified if registration was unsuccessful for some reason, and the user may be prompted to re-attempt registration. In some embodiments, a user device such as a mobile phone may automatically connect, using a Bluetooth, WiFi, or other wireless connection for example, to the boots and obtain the MAC addresses of the boots. The MAC addresses may be transmitted, such as by an app on the user device, to the vendor.

After the boots have been registered 204, the user may then purchase charge counts, such as ‘n’ charges of each boot heater power source 206. The ‘n’ charges may collectively correspond to a particular number of hours of operation time for the heaters.

With continued reference now to the example of FIG. 2, a user purchase of a charge count may be effected by way of a vendor website accessed for example, by an app or browser on a mobile phone of a user. The vendor site may receive the charge request from the user and process the purchase 208. The charge may then be authorized 210 by the vendor site, and an authorization code transmitted from the vendor site to the user who may then receive 212 the authorization code, and use the authorization code to update 214 the number of heater charges available. Once the charges are updated 216 at the boots, the heaters can then be used according to the purchase 206 made by the user.

As noted herein, communication between/among the user, boot circuitry, and cc vendor site, may be implemented by way of one or more wireless connections employed by an app and/or browser on a user mobile phone, and a wireless transmitter/receiver in the boot circuitry. Embodiments of the invention need not employ a mobile phone and extend, more generally, to any other device configured for wireless communication. Hard connections, such as a cable connecting a boot circuit and a mobile device, may be employed as well in some embodiments.

While not specifically indicated in FIG. 2, in some embodiments, a third party (see FIG. 1, 108), such as a ski resort that rents out ski boots, may act as the vendor, or the user, in the method 200. In still other embodiments, a third party, such as a ski resort for example, may interact with the vendor to handle the charging of the boots and/or the third party may control the charging of the boots and may then be billed by the vendor on a periodic basis, or at the end of the season, for the total number of heater charges performed by the third party.

With reference next to FIG. 3, an example method 300 for charging and using a boot heater is disclosed. The method 300 may be performed after one or more charges have been authorized, and may begin when a user connects a boot heater charging port 302 on one or more ski boots to a charging power source, such as a wall outlet for example. Some embodiments may provide for a single charger configured to charge 2 boots simultaneously.

After the boots have been connected 304 to the charger, a charge count circuit of the boots may be interrogated 306 to determine a charge count. Even if the charge count=0, charging of the boot heaters power supply may commence 308, but the user will not cc be able to use the charged power supply to operate the boot heaters until additional charge counts have been purchased. Thus, the boot heaters may be fully charged in anticipation of the purchase of further charge counts so that when the counts are purchased, the boot heaters are ready for immediate use.

On the other hand, if the charge count #0 at 306, then the paid charge count may be decremented 310 by ‘1’ and thus allow the battery connected to the boot heater to fully charge 312. After the battery is fully charged 312, the charge count may be checked 314 again.

If, after the power supply has been fully charged 312, the charge count is determined 314 to be not >0, then the heater circuits may not be activated 316. That is, the boot heaters may be fully charged, as a result of charging at 312, in anticipation of the purchase of further charge counts, but the heater circuits may not be activated 316 because the charge count has been determined 314 to be 0. Thus, the boot heaters may be fully charged 312 in anticipation of the purchase of further charge counts so that when the counts are purchased, the boot heaters are ready for immediate use. In some embodiments, a determination 314 that the charge count is not >0, may cause the generation of a message by an app, for example, stating ‘Purchase Charge Counts’ and indicating to the user that there are no charges remaining. The generation of the message may be performed, for example, based on non-activation 316 of the charge circuit, or based on awareness that (i) the power supply has been charged 312, and (ii) the charge count has been determined 314 to be 0.

On the other hand, if the charge count is determined 314 to be >0, then the cc heater circuits may be activated 318. The heater may then remain in operation until the power of the power source is exhausted 320. The user may turn the heater on and off any number of times, according to the needs of the user, but once the power source is exhausted 320 and in need of a recharge, the method 300 may return to 302.

It is noted that the methods 200 and 300 are presented by way of example and not limitation. As such, various alternative approaches may be employed. For example, where heated ski boots are rented out by a third party, such as a ski shop or ski resort for example, the third party may be charged by the vendor at the end of the season based, for example, on the number of days that the boots were turned on. This usage information may be obtained, for example, by standard software that may be used to read all the ski boot charge circuits. These metrics showing heated boot charges may be helpful to the third party in determining, for example, how many pairs of heated boots to buy each year.

Embodiments of the invention may provide for approaches to address unusual circumstances relating to the charging and/or operation of the ski boot heaters. For example, if a charge is unable to be started, or completed, due to a malfunction in the charger or power source, a corresponding error message may be displayed on a user app, and/or transmitted to a vendor. When a charge is unable to be completed due to such a malfunction, the charge count may not be decremented until the next time that the user is able to fully charge the power source. As another example, embodiments may be configured so that the boot heater may not be able to be activated by the user until the power source is fully charged. Since a charge count may only be decremented after a full charge, a user could try to sidestep the decrement by only partially charging the power cc source. By preventing heater activation until after a full charge is completed, this circumstance may be avoided.

### E. Example Components and Circuits

Following are some further details concerning example components that may be used in connection with one or more embodiments of the invention. It is noted however that no particular component is required to be employed in any embodiment.

In general, and further to the disclosure elsewhere herein, some example embodiments of the invention embrace a cold weather boot, such as a ski boot for example, that comprises a heated ski boot FOD (Function on Demand). For example, at the time of purchase, the ski boot heating functionality may only be available to the user if the user purchases charge counts, which may also be referred to herein as heat counts. As noted elsewhere herein, a ‘charge’ refers to a single, full, recharge of the power source that serves a ski boot heating element. Thus, in some embodiments, if the end user of the ski boots desires to use the ski boot heating feature, the user may be required to purchase one or more heat counts online through a vendor ecommerce website, where each authorized heat count enables a single full recharge of the heating system power source. When that user registers on the ecommerce website, a Bluetooth address, or other address, for each ski boot is registered with the vendor.

After the user purchases one or more heat counts, such as by way of the ecommerce website or a mobile phone app for example, a secure authorization token may be generated by the vendor and communicated to the ski boots, such as by way of a backend process and an app for example. When a heat count is used, that is, when the cc power source(s) for the boot heater(s) is/are enabled to be fully recharged, the total heat counts remaining may be decremented by 1, and another heat count may be used for the next recharge cycle. When all the purchased heat counts are used, that is, the heat count has decremented to 0, the user may purchase one or more additional heat counts, or purchase an unlimited number of heat counts, possibly at a higher cost than for a limited number of heat counts.

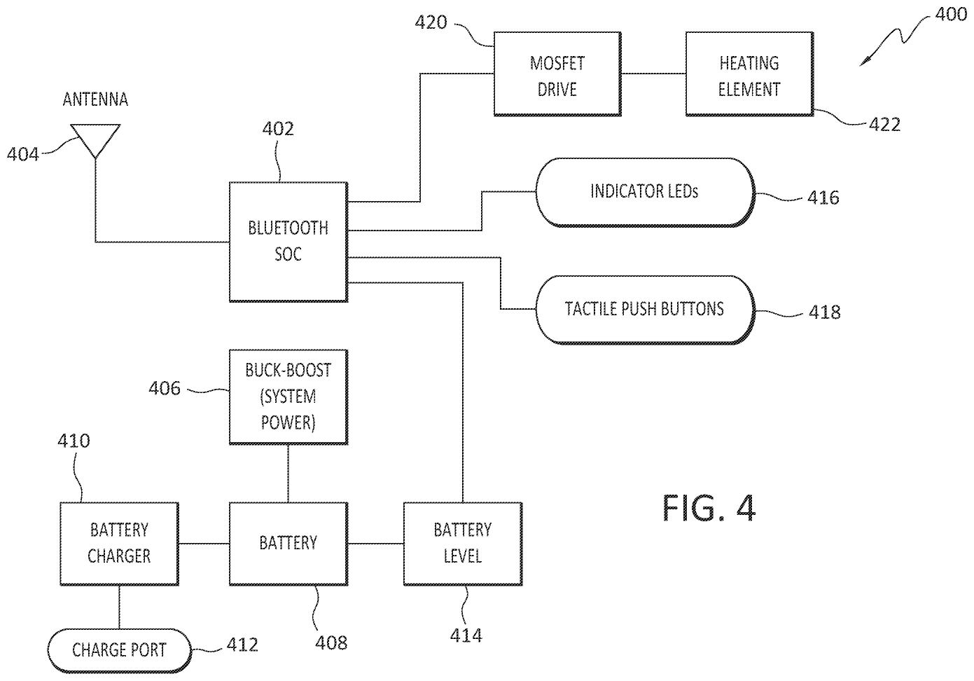

With particular attention now to FIG. 4, details are provided concerning aspects of example circuitry 400 that may be employed in some embodiments of the invention. Example embodiments of the circuitry 400, which may be incorporated in a ski boot, may be referred to as implementing a heated ski boot FOD (Function on Demand). In general, various components may be included in the circuitry 400 and the following particular components are prevented only by way of example and are not intended to limit the scope of the invention in any way.

The use of the FOD terminology embraces the notion that a user may, upon satisfaction of certain criteria, obtain performance of a function, namely, operation of a boot heater, on demand when the user chooses to activate the boot heater. The criteria include the purchase of charge counts adequate to ensure that the power supply can be charged, and the boot heater circuit activated.

In some implementations, the circuitry 400 may include a microcontroller 402, such as the Bluetooth SOC (Solution On a Chip). Particularly, the main Bluetooth microcontroller may be the CC2640R2F SOC. One example of a suitable microcontroller is the Laird SaBLE-x-R2, which is an FCC and CE preapproved module. This is a low-cost and cc low-power consumption module with all Bluetooth 5 Low Energy functionalities. The module fully supports the single mode Bluetooth Low Energy operation, and the output power can support class 2. This module provides the ability to put an entire application into the CC2640R2F integrated ARM Cortex M3 microcontroller.

Embodiments of the example circuitry 400 may be configured for wireless communication with various entities, including a mobile phone and a vendor ecommerce site, for example. As such, the example circuitry 400 may include one or more antennas 404 for transmitting and/or receiving signals. One particular antenna that may be employed in some embodiments is a 2.4 GHz Bluetooth, PCB Trace RF antenna integrated trace surface mount.

The example circuitry 400 may also include a buck boost converter 406 (system power). In general, the buck boost converter may be to supply a fixed regulated voltage required for both analog and digital components of the circuitry 400. The buck boost controller integrated circuit (IC) input voltage may be taken from any power source that may operate over a wide range of voltages, such as those supplied by a chemical battery for example.

As noted elsewhere herein, the circuitry 400 may include a rechargeable power source 408, one example of which is a lithium-ion battery. In some embodiments, all systems on the heated ski boot are powered by the battery. The use of any other power source is not excluded, and other battery chemistries and/or super capacitors could be used as a power source in other embodiments. The power source 408 may be connected to a battery charger 410 which, in turn, may be connected to a charging port 412 which cc may be configured to removably receive a charging cord or cable connected to a charging power source (not shown).

The example circuitry 400 may include a battery level circuit 414. The battery level circuit 414 may be implemented, for example, as a sample and hold circuit that includes a load switch and voltage divider. This battery level circuit 414 may condition the battery voltage from the main power source to voltage levels that are compatible with the input of the A/D (Analog/Digital) converter of the microcontroller 402. The battery level circuit 414 may be used to monitor the battery 408 voltage level, such as by way of a task running on the microcontroller that runs on a relatively frequent basis. If the battery or main power source voltage drop below preset levels, such as a low, the end user may be notified, such as by way of an app on a mobile phone of a user.

Some embodiments of the circuitry 400 may include various indicators 416 operable to emit signals perceptible by a user, such as light sources, vibrating elements, and sound generation devices. Such indicators may be used to convey information such as, but not limited to, status, warnings, power levels, and malfunctions. In one example embodiment, a heated ski boot has integrated, and molded into it, three LED (Light Emitting Diode) for indicating a selected heat level, high, medium, or low. In this example, one illuminated LED indicates a ‘low’ heat setting, two illuminated LEDs indicate a ‘medium’ heat setting, and three illuminated LEDs indicate a ‘high’ heat setting. These LEDs, or other indicators, may be controlled by the Bluetooth SOC, or other microcontroller.

Example embodiments of the circuitry 400 may also include various controls 418 that are operable by a user or other person. One example of such a control 418 is a cc pushbutton. In some embodiments, a ski boot may have, integrated and molded into it, two pushbuttons for selecting a heat level, such as ‘high,’ ‘medium,’ or ‘low.’ One pushbutton may be labeled UP, or ‘+,’ and the other pushbutton may be labeled DOWN or ‘-.’ Pushing the UP button will increase the heat level of the heated ski boot. Pushing the DOWN button will decrease the heat level of the heated ski boot. It may also be possible to use an app to configure various parameters of the heating system. For example, some embodiments of the app, such as an app on an Android® or Apple® device for example, may be used to set heat levels using a Bluetooth connection with the ski boots. The heaters may also be turned on and off using the app.

Another element that may be included in embodiments of the circuitry 400 is a MOSFET (Metal Oxide Semiconductor Field Effect Transistor) based driver 420. For example, a simple MOSFET transistor may be used for driving the heated ski boot heating element. Firmware running on the Bluetooth SOC may control the MOSFET to obtain a desired ski boot heat level by using a PWM (Pulse Width Modulation) method.

Finally, example embodiments of the circuitry 400 may comprise one or more heating elements 422. In some embodiments, a heating element is integrated and molded into the toe section of the ski boot. The heating pad(s) of the heating element may be constructed using a mesh of polyester filament and micro metal conductive fiber folded into a protective polyimide film. This configuration may provide a heating element that is flexible, and that draws little power.

### F. Example Computing Devices and Associated Media

The embodiments disclosed herein may include the use of a special purpose or cc general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory cc storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to cc carry out executable instructions for performing a method or process, such as the methods and processes disclosed herein. The hardware processor may or may not comprise an element of other hardware, such as the computing devices and systems disclosed herein. In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

### G. Example Computing Entity

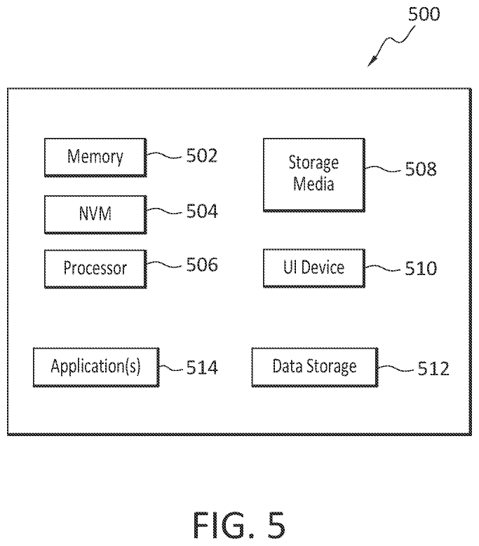

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions cc executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

### H. Further Example Embodiments

Following are some further example embodiments of the invention. These are presented only by way of example and are not intended to limit the scope of the invention in any way.

Embodiment 1. A ski boot, comprising: a shell; and a heating system, the heating system comprising: a heating element embedded within a liner of the ski boot; and heating element circuitry connected to the heating element and configured to be selectively activated, wherein the heating element circuitry comprising: a charging port; a rechargeable power source connected to the charging port and to the heating element; and a charge counter circuit connected to the charging port and to the rechargeable power source, wherein the charge counter circuit is operable to count a number of times that the rechargeable power source has received power by way of the charging port.

Embodiment 2. The ski boot as recited in embodiment 1, further comprising a wireless transmitter and wireless receiver, both of which are connected to the charge counter circuit.

Embodiment 3. The ski boot as recited in any of embodiments 1-2, wherein [0081] the heating element comprises an electrical resistor.

Embodiment 4. The ski boot as recited in any of embodiments 1-3, wherein the heating system has a MAC address that enables the heating system to communicate with one or more external computing entities.

Embodiment 5. The ski boot as recited in any of embodiments 1-4, wherein the charge counter circuit is operable to report a charge count to an external system and/or device by way of a wireless connection.

Embodiment 6. The ski boot as recited in any of embodiments 1-5, wherein the charge counter circuit is operable to communicate with an app on a mobile phone.

Embodiment 7. The ski boot as recited in any of embodiments 1-6, wherein the ski boot is operable to communicate wirelessly with one or more computing entities.

Embodiment 8. A computer readable storage medium carrying instructions executable by one or more hardware processors to perform operations comprising: receiving user input; based on the user input, requesting registration of a ski boot; receiving confirmation of registration of the ski boot; submitting transaction information; receiving an authorization code based on approval of the transaction information; and using the authorization code to update a charge count of the ski boot.

Embodiment 9. The computer readable storage medium as recited in embodiment 8, wherein one or more of the operations are performed by an app on a cc mobile phone.

Embodiment 10. The computer readable storage medium as recited in any of embodiments 8-9, wherein requesting registration comprises sending a request to a vendor site.

Embodiment 11. The computer readable storage medium as recited in embodiment 10, wherein the confirmation of registration is received from the vendor site.

Embodiment 12. The computer readable storage medium as recited in any of embodiments 8-9, wherein the transaction information is submitted to a vendor site.

Embodiment 13. The computer readable storage medium as recited in embodiment 12, wherein the authorization code is received from the vendor site.

Embodiment 14. A computing device, such as a mobile phone for example, comprising one or more hardware processors, and comprising the computer readable storage medium as recited in any of embodiments 8-13.

Embodiment 14. A computer readable storage medium carrying instructions executable by one or more hardware processors to perform operations comprising: receiving a request for registration of a ski boot; registering the ski boot in a database; receiving transaction information; evaluating the transaction information and authorizing a transaction when one or more criteria are met; and transmitting an authorization code usable to update a heating system charge count of the ski boot.

Embodiment 15. The computer readable storage medium as recited in embodiment 14, wherein one or more of the operations are performed at a vendor site.

Embodiment 16. The computer readable storage medium as recited in any of cc embodiments 14-15, wherein the request is received from an app or web browser of a Embodiment 17. The computer readable storage medium as recited in any of embodiments 14-16, wherein the transaction information includes payment information.

Embodiment 18. The computer readable storage medium as recited in any of embodiments 14-17, wherein the authorization code is transmitted to an app or web browser of a mobile phone.

Embodiment 19. The computer readable storage medium as recited in any of embodiments 14-18, wherein the ski boot is one of a pair, and the authorization code is unique to the pair of ski boots.

Embodiment 20. A vendor computing device, such as a server for example, comprising one or more hardware processors, and the computer readable storage medium as recited in any of embodiments 14-19.

Embodiment 21. A heating system configured to be installed in a boot, and the heating system comprising: a heating element configured to be partly, or completely, embedded within a shell, or within a liner, of the boot; and heating element circuitry connected to the heating element and operable to be selectively activated, wherein the heating element circuitry comprises: a charging port; a rechargeable power source connected to the charging port and to the heating element; and a charge counter circuit connected to the charging port and to the rechargeable power source, wherein the charge counter circuit is operable to count a number of times that the rechargeable power source has received power by way of the charging port.

Embodiment 22. The heating system as recited in embodiment 21, wherein the charging port and the rechargeable power source are configured to be disposed exterior to an outer surface of the boot, or interior to an outer surface of the boot, or within a shell or liner of the boot.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A ski boot, comprising:
a shell;
a liner configured to be partly disposed within the shell; and
a heating system, the heating system comprising:
a heating element embedded in the liner; and
heating element circuitry connected to the heating element, and configured to be selectively activated, wherein the heating element circuitry comprises:
a charging port;
a rechargeable power source connected to the charging port and to the heating element; and
a charge counter circuit connected to the charging port and to the rechargeable power source, wherein the charge counter circuit is operable to count a number of times that the rechargeable power source has received power by way of the charging port.

2. The ski boot as recited in claim 1, further comprising a wireless transmitter and wireless receiver, both of which are connected to the charge counter circuit.

3. The ski boot as recited in claim 1, wherein the heating element comprises an electrical resistor.

4. The ski boot as recited in claim 1, wherein the heating system has a MAC address that enables the heating system to communicate with one or more external computing entities.

5. The ski boot as recited in claim 1, wherein the charge counter circuit is operable to report a charge count to an external system and/or device by way of a wireless, and/or hardwired, connection.

6. The ski boot as recited in claim 1, wherein the charge counter circuit is operable to communicate with an app on a mobile phone.

7. The ski boot as recited in claim 1, wherein the ski boot is operable to communicate wirelessly with one or more computing entities.

8. A computer readable storage medium carrying instructions executable by one or more hardware processors to perform operations comprising:
receiving user input;
based on the user input, requesting registration of a ski boot;
receiving confirmation of registration of the ski boot;
submitting transaction information;
receiving an authorization code based on approval of the transaction information; and
using the authorization code to update a charge count of the ski boot.

9. The computer readable storage medium as recited in claim 8, wherein the instructions comprise a portion of an app on a mobile phone that includes one or more hardware processors.

10. The computer readable storage medium as recited in claim 8, wherein requesting registration comprises sending a request to a vendor site.

11. The computer readable storage medium as recited in claim 10, wherein the confirmation of registration is received from the vendor site.

12. The computer readable storage medium as recited in claim 8, wherein the transaction information is submitted to a vendor site.

13. The computer readable storage medium as recited in claim 12, wherein the authorization code is received from the vendor site.

14. A computer readable storage medium carrying instructions executable by one or more hardware processors to perform operations comprising:
receiving a request for registration of a ski boot;
registering the ski boot in a database;
receiving transaction information;
evaluating the transaction information and authorizing a transaction when one or more criteria are met; and
transmitting an authorization code usable to update a heating system charge count of the ski boot.

15. The computer readable storage medium as recited in claim 14, wherein one or more of the operations are performed at a vendor site.

16. The computer readable storage medium as recited in claim 14, wherein the request is received from an app or web browser of a mobile phone.

17. The computer readable storage medium as recited in claim 14, wherein the transaction information includes payment information.

18. The computer readable storage medium as recited in claim 14, wherein the authorization code is transmitted to an app or web browser of a mobile phone.

19. The computer readable storage medium as recited in claim 14, wherein the ski boot is one of a pair, and the authorization code is unique to the pair of ski boots.

20. A system, comprising: one or more hardware processors; and, the computer readable storage medium as recited in claim 14.
